(19) United States
(12) Patent Application Publication
(10) Pub. No.: US 2021/0400958 A1
(43) Pub. Date: Dec. 30, 2021

(54) ANTIMICROBIAL ARTICLE AND MANUFACTURING METHOD THEREOF

(71) Applicant: MCK Co., Ltd., Cheongju-si Chungcheongbuk-do (KR)

(72) Inventors: Deog Ju MOON, Cheongju-si Chungcheongbuk-do (KR); Si Hyeong CHO, Cheongju-si Chungcheongbuk-do (KR); Ha Jung LEE, Cheongju-si Chungcheongbuk-do (KR)

(73) Assignee: MCK Co., Ltd.

(21) Appl. No.: 17/347,267

(22) Filed: Jun. 14, 2021

(30) Foreign Application Priority Data
Jun. 29, 2020 (KR) 10-2020-0078970
Jun. 29, 2020 (KR) 10-2020-0078971

(51) Int. Cl. A01N 25/34; B29C 59/02; A01N 25/10; A01N 59/20; B29C 35/02

(52) U.S. Cl. CPC A01N 25/34; B29C 59/02; B29C 35/0266; A01N 59/20; A01N 25/10

(57) ABSTRACT

An antimicrobial article includes a flexible substrate; and a plurality of first protrusions which is formed on at least one surface of the substrate, includes a crosslinked polymer resin and antimicrobial materials dispersed in the polymer resin, and is formed with first grooves in which at least one of bacteria, fungi, and viruses may be received. According to the present disclosure, in the antimicrobial article and the manufacturing method thereof, it is possible to greatly improve the antimicrobial effect of the antimicrobial article by minimizing a distance between bacteria, fungi, or viruses attached to the antimicrobial article and antimicrobial materials of the antimicrobial article to maximize the quantity of the antimicrobial materials that affect the bacteria, fungi, or viruses.

### CROSS-REFERENCE TO RELATED APPLICATION

This application claims priority under 35 U.S.C. § 119(a) to Korean Patent Application No. 10-2020-0078970 filed in the Korean Intellectual Property Office on Jun. 29, 2020, and Korean Patent Application No. 10-2020-0078971 filed in the Korean Intellectual Property Office on Jun. 29, 2020, the entire contents of which are incorporated herein by reference.

### BACKGROUND

### (a) Technical Field

The present disclosure relates to an antimicrobial article and a manufacturing method thereof with improved antimicrobial effect of the antimicrobial article by forming the surface of the antimicrobial article to protrude.

### (b) Background Art

Conventional antimicrobial articles have been mostly manufactured in the form of films. The antimicrobial film is an article in which antimicrobial materials are uniformly dispersed in the film and the surface of the antimicrobial film is flat. Such an antimicrobial film is attached to other objects by using a double-sided tape adhering onto one surface or by using a one-sided tape after closely contacting the antimicrobial film and the object.

When bacteria, fungi or viruses are attached to the flat surface of the antimicrobial film, the antimicrobial materials in the antimicrobial film have an antimicrobial effect that kills bacteria, fungi or viruses attached to the surface of the antimicrobial film or inhibits the growth of bacteria, fungi or viruses. However, since the amount of the antimicrobial materials included in the antimicrobial film is very small because of transparency of articles, reduced production costs, etc., it is required to improve the performance of the antimicrobial article by maximizing an antimicrobial effect of each antimicrobial material.

Further, since the antimicrobial article is prepared typically by simply extruding a mixture of antimicrobial materials and a polymer resin, the antimicrobial article is manufactured only in a film shape having a flat surface. Accordingly, it is difficult to change the components of the antimicrobial film, and there is also a limit to improve the antimicrobial performance.

The above information disclosed in this Background section is only for enhancement of understanding of the background of the disclosure and therefore it may contain information that does not form the prior art that is already known in this country to a person of ordinary skill in the art.

### SUMMARY OF THE DISCLOSURE

The present disclosure is derived to solve the above problems, and an object of the present disclosure is to provide an antimicrobial article and a manufacturing method thereof capable of greatly improving the antimicrobial performance of the antimicrobial article by minimizing distances between bacteria, fungi, or viruses attached to the antimicrobial article and antimicrobial materials of the antimicrobial article to maximize the quantity of the antimicrobial materials that affect the bacteria, fungi, or viruses.

According to an aspect of the present disclosure, there is provided an antimicrobial article including: a flexible substrate; and a plurality of first protrusions which is formed on at least one surface of the substrate, includes a crosslinked polymer resin and antimicrobial materials dispersed in the polymer resin, and is formed with first grooves in which at least one of bacteria, fungi, and viruses may be received.

In an embodiment, the width of a lower surface of the groove in which at least one of bacteria, fungi, and viruses may be received is smaller than the size of at least one of bacteria, fungi, and viruses and at least one of the depth and the width of the groove is equal to or larger than the size of at least one of bacteria, fungi, and viruses.

In an embodiment, the density of the antimicrobial material may be higher in close to the surface of the protrusion than the center of gravity of the protrusion, or higher in close to an edge of a cut cross section than a center of the cut cross section when the protrusion is cut to a horizontal plane with a bottom of the protrusion.

In an embodiment, at least some of the antimicrobial materials may be at least partially exposed out of the surface of the protrusion.

In an embodiment, the antimicrobial materials exposed out of the surface of the protrusion may be coated with a hydrophobic material.

In an embodiment, the polymer resin of the protrusion may further include a hydrophilic material.

In an embodiment, at least one of the depth and the width of the groove in which at least one of bacteria, fungi, and viruses may be received is 5 μm or more.

In an embodiment, the width of a top surface of the protrusion may be smaller than the size of the at least one of bacteria, fungi, and viruses.

In an embodiment, at least one of the protrusions may include a recessed groove in which at least one of bacteria, fungi, and viruses may be received, and at least one of the depth and the width of the recessed groove may be equal to or larger than the size of at least one of bacteria, fungi, and viruses.

In an embodiment, the recessed groove may be recessed in a vertical direction to the bottom or the side surface of the protrusion.

According to another aspect of the present disclosure, there is provided an antimicrobial article including: a flexible substrate; a plurality of first protrusions which is formed at a first height on at least one surface of the flexible substrate and includes a crosslinked polymer resin and antimicrobial materials dispersed in the polymer resin; and at least one second protrusion which is formed between at least two first protrusions among the first protrusions, has a second height smaller than the first height, and includes a crosslinked polymer resin and antimicrobial materials dispersed in the polymer resin, wherein at least one groove in which at least one of bacteria, fungi, and viruses may be received is formed by the first protrusion and the second protrusion.

In an embodiment, the width of a lower surface of the groove in which at least one of bacteria, fungi, and viruses may be received is smaller than the size of at least one of bacteria, fungi, and viruses, and at least one of the depth and the width of the groove in which at least one of bacteria, fungi, and viruses may be received is equal to or larger than the size of at least one of bacteria, fungi, and viruses.

In an embodiment, the density of the antimicrobial material may be higher in close to the surface of the second protrusion than the center of gravity of the second protrusion, or higher in close to an edge of a cut cross section than a center of the cut cross section when the second protrusion is cut to a horizontal plane with a bottom of the second protrusion.

In an embodiment, at least some of the antimicrobial materials may be at least partially exposed out of the surface of the second protrusion.

In an embodiment, the antimicrobial materials exposed out of the surface of the second protrusion may be coated with a hydrophobic material.

In an embodiment, the width of a top surface of at least one of the first protrusion and the second protrusion may be smaller than the size of at least one of bacteria, fungi, and viruses.

According to yet another aspect of the present disclosure, there is provided a method for manufacturing an antimicrobial article in a method for manufacturing a polishing article formed with a plurality of protrusions, the method including: generating a mixture by mixing uniformly antimicrobial materials with a polymer resin; filling the mixture in a mold engraved in shapes and sizes corresponding to the plurality of protrusions; attaching a substrate to the surface of the mixture filled in the mold; curing the mixture filled in the mold; and removing the mold from the cured mixture.

In an embodiment, the method may further comprise controlling a location of the antimicrobial materials in the mixture or a density according to the location.

In an embodiment, the controlling of the location of the antimicrobial materials in the mixture or the density according to the location may be to move the antimicrobial materials in the mixture in close to the surface of the mold.

In an embodiment, the location of the antimicrobial materials or the density according to the location may be controlled by at least one of a volume of the antimicrobial material and a mass of the antimicrobial material and a time until the mixture is completely cured after the mixture is filled in the mold.

According to the present disclosure, in the antimicrobial article and the manufacturing method thereof, it is possible to greatly improve the antimicrobial performance of the antimicrobial article by minimizing distances between bacteria, fungi, or viruses and antimicrobial materials of the antimicrobial article when the bacteria, fungi, or viruses are attached to the antimicrobial article to maximize the amount of the antimicrobial materials that affect the bacteria, fungi, or viruses.

It should be understood that the effects of the present disclosure are not limited to the effects described above, but include all effects that can be deduced from the detailed description of the present disclosure or configurations of the disclosure described in appended claims.

### BRIEF DESCRIPTION OF THE DRAWINGS

FIG. 1 is a perspective view showing an antimicrobial article according to an embodiment of the present disclosure.

FIG. 2 is a cross-sectional view showing an antimicrobial article according to an embodiment of the present disclosure.

FIG. 3 is a cross-sectional view showing an antimicrobial article according to another embodiment of the present disclosure.

FIG. 4 is a cross-sectional view showing an antimicrobial article according to yet another embodiment of the present disclosure.

FIG. 5 is a cross-sectional view showing an antimicrobial article according to yet another embodiment of the present disclosure.

FIG. 6 is a cross-sectional view showing an antimicrobial article according to yet another embodiment of the present disclosure.

FIG. 7 is a cross-sectional view showing an antimicrobial article according to yet another embodiment of the present disclosure.

FIGS. 8 and 9 are cross-sectional views showing an antimicrobial article according to yet another embodiments of the present disclosure.

FIG. 10 is a flowchart illustrating a method for manufacturing an antimicrobial article according to the present disclosure.

FIGS. 11 to 16 are diagrams illustrating results of testing antimicrobial effects of the antimicrobial article according to the present disclosure.

FIGS. 17 to 18 are diagrams illustrating results of testing antiviral effects of the antimicrobial article according to the present disclosure.

### DETAILED DESCRIPTION

Terms used in the present disclosure are used only to describe specific embodiments, and are not intended to limit the present disclosure. A singular form may include a plural form unless otherwise clearly meant in the context. In the present disclosure, it should be understood that the term “comprising”, “including”, or “having” indicates that a feature, a number, a step, an operation, a component, a part or a combination thereof described herein is present, but does not exclude a possibility of presence or addition of one or more other features, numbers, steps, operations, components, parts, or combinations thereof, in advance.

In addition, as used herein, the term “on or above” is referred to as being located above or below a target portion, and is not necessarily meant as being located on an upper side based on a direction of gravity. Further, it will be understood that when a part such as a region or a substrate is “on or above” the other part, the part is contacted or spaced “directly on or above” the other part or another part may also be present therebetween.

Further, in this specification, if it is described that one component is “connected” or “accessed” with the other component, it should be understood that the one component may be directly connected to or may directly access the other component, but unless otherwise explicitly described, another component may be connected or accessed therebetween.

Further, in the detailed specification, the terms such as first, second, and the like may be used for describing various components, but the components are not limited by the terms. The terms are used only to discriminate one component from the other component.

Hereinafter, preferred embodiments, advantages and features of the present disclosure will be described in detail with reference to the accompanying drawings.

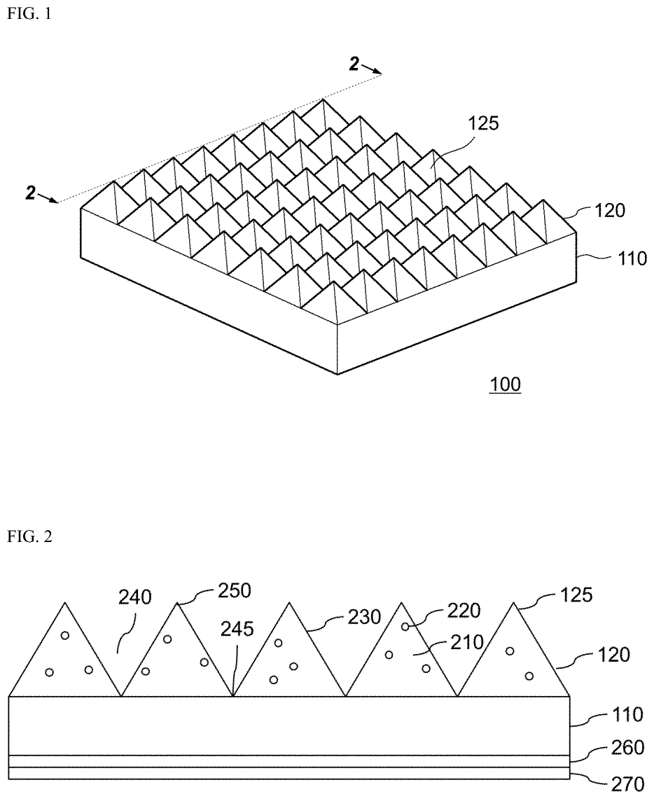

FIG. 1 is a perspective view showing an antimicrobial article according to an embodiment of the present disclosure and FIG. 2 is a cross-sectional view showing an antimicrobial article according to an embodiment of the present disclosure.

Referring to FIGS. 1 and 2, an antimicrobial article 100 includes an antimicrobial layer 120 formed with a plurality of protrusions 125 and a substrate 110 supporting the antimicrobial layer 120. The substrate 110 needs to be flexible so that the antimicrobial article 100 is attached to objects having various shapes. The substrate 110 may be made of a transparent material so as to transmit light up to an object covered by the antimicrobial article 100 even after the antimicrobial article 100 is attached to an object. The antimicrobial layer 120 consists of a polymer resin 210 to be crosslinked, and antimicrobial materials 220 are dispersed in the polymer resin 210. The antimicrobial materials 220 may be uniformly or ununiformly dispersed in the polymer resin 210. In one embodiment of the present disclosure, the antimicrobial materials 220 are uniformly dispersed in the polymer resin 210.

The protrusions 125 may be formed in various shapes, such as a cylinder, a cone, a truncated cone, a polyprism, a polypyramid, a truncated polypyramid, and a hemisphere. In FIG. 1 or 2, to make it easy to describe the present disclosure, the antimicrobial layer 120 formed with the protrusions 125 having the same shape and size has been illustrated, but the protrusions 125 may be formed in two shapes. For example, among the plurality of protrusions 125, protrusions in a first group may be formed in a first shape and protrusions in a second group may be formed in a second shape. Further, the protrusions 125 may also be formed in three or more shapes. The sizes of the protrusions 125 may be different from each other, and the shape and size of each protrusion 125 may be varied.

Further, as illustrated in FIGS. 1 and 2, the protrusions 125 may be formed to be close to each other or spaced apart from each other. When the protrusions 125 are spaced apart from each other, the antimicrobial layer 120 may be formed so that distances between the protrusions 125 are all the same as each other. Alternately, among the protrusions 125 of the antimicrobial layer 120, the distances between some protrusions may be different from the distances between other protrusions, and the distances between the protrusions 125 may be different from each other.

In the present disclosure, the forming the antimicrobial layer 120 with the protrusions 125 is to increase the amount of the antimicrobial materials 220 that affect bacteria, fungi and viruses by making distances between the bacteria, fungi and viruses attached on the surface of antimicrobial layer 120 and the antimicrobial materials 220 in the antimicrobial layer 120 shorter.

For example, unlike the antimicrobial article 100 of the present disclosure, if bacteria are attached to an antimicrobial film having a flat surface and a constant thickness, among the antimicrobial materials in the antimicrobial film, the antimicrobial materials immediately below the surface to which the bacteria are attached are very close to the bacteria. On the other hand, the antimicrobial materials inside the antimicrobial film or in close to an opposite side of the surface to which the bacteria are attached are relatively far away from the bacteria. In this case, an antimicrobial effect on the corresponding bacteria of the antimicrobial materials located in close to the surface to which the bacteria are attached is relatively large, and as the location of the antimicrobial materials is closer to the opposite side of the surface to which the bacteria are attached, the antimicrobial effect on the corresponding bacteria may be relatively smaller. That is, the effect by the antimicrobial materials configuring the antimicrobial film may not be sufficiently used. Further, since the antimicrobial materials are dispersed in the antimicrobial film, there is an area without the antimicrobial materials in close to the surface of the antimicrobial film. If there is no antimicrobial material in close to the surface to which the bacteria are attached, the antimicrobial effect on the bacteria may be relatively low as compared with an area with the antimicrobial materials in close to the surface. That is, a difference in antimicrobial effect occurs depending on a location of the bacteria on the surface of the antimicrobial film.

On the other hand, as shown in FIG. 2, the antimicrobial layer 120 of the antimicrobial article 100 according to the present disclosure includes a plurality of protrusions 125, and the protrusion 125 consists of a crosslinked polymer resin 210 and antimicrobial materials 220 dispersed in the polymer resin 210. To be easily understood, it is assumed that all the protrusions 125 of the antimicrobial layer 120 have the same shape and height, and the protrusions 125 are close to each other. When the bacteria are attached to the surface of the antimicrobial layer 120, the corresponding bacteria will be attached to a top surface 250 of the protrusion 125, a side surface 230 of the protrusion 125, or a lower surface 245 of a groove 240 between the protrusions 125. If the bacteria are located on the top surface 250 of the protrusion 125, it will be expected to have an antimicrobial effect of the antimicrobial materials 220 in close to the top surface 250 of the protrusion 125 on the bacteria. This effect will be similar to the antimicrobial effect of the antimicrobial film described above. But, if the bacteria are located on the side surface 230 of the protrusion 125 or the lower surface 245 of the groove 240, it will be expected to have the antimicrobial effect by the antimicrobial materials 220 in close to the side surface 230 of the protrusion 125 or the lower surface 245 of the groove 240. Here, the antimicrobial materials 220 in close to the side surface 230 of the protrusion 125 or the lower surface 245 of the groove 240 correspond to the antimicrobial materials in the antimicrobial film described above. In the present disclosure, the antimicrobial effect by the antimicrobial materials 220 in close to the side surface 230 of the protrusion 125 or the lower surface 245 of the groove 240 is an antimicrobial effect which cannot be expected in the antimicrobial film described above. Accordingly, in the antimicrobial film described above, unlike a low antimicrobial effect by the antimicrobial materials inside the antimicrobial film, in the antimicrobial article 100 according to the present disclosure, the antimicrobial effect by all the antimicrobial materials 220 present inside the antimicrobial layer 120 may be fully utilized.

Such an effect may be described in another aspect, and if there is an antimicrobial film formed with the same height as the antimicrobial layer 120 and the amount of the antimicrobial material included in the antimicrobial film is the same as the amount of the antimicrobial material included in the antimicrobial layer 120, the density of the antimicrobial materials 220 in the antimicrobial layer 120 formed with the protrusions 125 is higher than the density of the antimicrobial film with a flat surface. The reason is that the amount of the polymer resin of the antimicrobial layer 120 is smaller than the amount of the polymer resin of the antimicrobial film because of an empty space occupied by the groove between the protrusions 125, and on the contrary, the density of the antimicrobial materials 220 in the antimicrobial layer 120 is increased. As a result, there is an effect of reducing an average distance between the antimicrobial materials 220 and the bacteria, thereby improving an average antimicrobial effect by the antimicrobial materials.

Further, since the top surface 250 of the protrusion 125 or the lower surface 245 of the groove 240 is sharp, the area is too small for the bacteria to be located, so there is a relative high probability that the bacteria will be located on the side surface 230 of the protrusion 125. If the bacteria are located on the side surface 230 of the protrusion 125, the antimicrobial effect by the antimicrobial materials 220 of the adjacent protrusion 125 may be also expected with the antimicrobial effect by the antimicrobial materials 220 configuring the protrusions 125 where the bacteria are located. In the case of the antimicrobial film described above, there is a two-dimensional antimicrobial effect that affects the corresponding bacteria only in the area where the bacteria are in the antimicrobial film, while in the antimicrobial article 100 according to the present disclosure, a three-dimensional antimicrobial effect may be expected by the protrusions 125 surrounding the corresponding bacteria. Therefore, the area generating the antimicrobial effect on the bacteria is increased, and accordingly, the amount of antimicrobial materials that affect the corresponding bacteria is also increased.

The substrate 110 is preferably made of a material that is flexible and easy to bond with the polymer resin 210 of the antimicrobial layer 120. For example, the substrate 110 consists of at least one of thermoplastic polyurethane (TPU), ethylenevinyl acetate (EVA), polymethyl methacrylate (PMMA), polyacrylic acid (PAA), polyamide (PA), polybutylene terephthalate (PBT), polyethylene terephthalate (PET), polycarbonate (PC), polyethylene (PE), polyimide (PI), polypropylene (PP), polyvinylchloride (PVC), and nylon. Among them, polyethylene terephthalate (PET) has been most commonly used. The thickness of the substrate 110 is preferably 50 to 150 μm. The reason is that when the thickness of the substrate 110 is less than 50 μm, it is easy to be torn, and when the thickness is more than 150 μm, the elasticity of the substrate 110 increases to reduce the flexibility of the antimicrobial article 100.

The polymer resin 210 is used with a thermo-curing resin or a photo-curing resin. The thermo-curing resin may be at least one selected from phenol, phenol formaldehyde, polyester, melamine formaldehyde, polyurethane, epoxy, urea formaldehyde, and silicon. The thermo-curing resin may be at least one selected from a photocrosslinking type, a photolytic type, and a photopolymerization type. Preferably, a phenol resin or a phenol formaldehyde resin may be used, and the reason is that there are advantages that the heat resistance and durability are excellent and the curing is easy while the price is relatively low. In addition, various types of known polymer resins may be used, and two or more types of polymer resins may be used in combination.

In the present disclosure, the antimicrobial materials 220 include at least one of antimicrobial metals, antimicrobial metal alloys, and antimicrobial metal-containing additives. The antimicrobial metals include cadmium, zinc, nickel, copper, lead, mercury, silver, etc., and silver, copper or zinc harmless to the human body is mainly used. The antimicrobial metal-containing additives include activated carbon, inorganic ion exchangers, porous zeolite, and the like. There is antimicrobial copper as the most commonly used material as the antimicrobial material 220, and the antimicrobial copper is pure copper or an alloy containing 60 wt % or more of copper, and for example, includes copper, brass, red brass, admiralty brass, cartridge brass, yellow brass, silicon aluminum manganese aluminum brass, aluminum bronze, silicon aluminum bronze, phosphor bronze, silicon bronze, manganese bronze, tin bronze, copper nickel, nickel silver, or the like.

In the present disclosure, the polymer resin 210 of the antimicrobial layer 120 is a thermo-curing resin or a photo-curing resin, and in the polymer resin 210 crosslinked by thermo-curing or photo-curing, the hardness is increased, while the flexibility may be decreased. Accordingly, it is preferred that the size of the protrusion 125 in the antimicrobial layer 120 is very small so that the antimicrobial article 100 is flexible. In order to manufacture the flexible antimicrobial article 100, it is preferred that the width of the protrusion 125 is 500 μm or less and the height of the protrusion 125 is 300 μm or less.

In order to implement the antimicrobial effect according to the present disclosure, the depth or width of the groove 240 is preferably much larger than the size of bacteria, fungi or viruses, so that the bacteria, fungi or viruses may be sufficiently received in the groove 240 between the protrusions 125. Here, the depth of the groove 240 is defined as a height of the lowest protrusion among two or more adjacent protrusions 125 forming the corresponding groove 240. Further, the width of the groove 240 may be defined as a distance from the top surface 250 of the protrusion 125 having the lowest height among two or more adjacent protrusions 125 forming the corresponding groove 240 to the side surface 230 of the adjacent protrusion 125. If the heights of the two or more adjacent protrusions 125 are the same as each other, the width of the groove 240 may be a distance between the top surfaces of the adjacent protrusions 125 forming the corresponding groove 240.

According to those known so far, the size of bacteria is 0.1 to 5 μm, the size of fungi is 5 to 20 μm, and the size of virus is 30 to 300 nm. Therefore, at least one of the depth and the width of the groove 240 is preferably 300 nm or more so that the antimicrobial article 100 according to the present disclosure exhibits the above-described antimicrobial effect on the viruses. Alternatively, at least one of the depth and the width of the groove 240 is preferably 5 μm or more so that the antimicrobial article 100 according to the present disclosure exhibits the above-described antimicrobial effect on the bacteria. Alternatively, at least one of the depth and the width of the groove 240 is preferably 20 μm or more so that the antimicrobial article 100 according to the present disclosure exhibits the above-described antimicrobial effect on the fungi. If at least one of the depth and the width of the groove 240 is 5 μm or more, the antimicrobial effect of the antimicrobial article 100 described above may be expected on bacteria and viruses. If at least one of the depth and the width of the groove 240 is 20 μm or more, the antimicrobial effect of the antimicrobial article 100 described above may be expected on bacteria, fungi, and viruses. That is, the antimicrobial effect may be selectively generated by adjusting the depth and the width of the groove 240.

In addition, two bacteria, fungi or viruses may be attached to the surfaces of two adjacent protrusions 125, respectively. If two or more viruses are received between the two adjacent protrusions 125, the width of the groove 240 is preferably 600 nm or more which is double the size of the viruses. Alternatively, if two or more bacteria are received between the two adjacent protrusions 125, the width of the groove 240 is preferably 10 μm or more which is double the size of the bacteria. Alternatively, if two or more fungi are sufficiently received between the two adjacent protrusions 125, the width of the groove 240 is preferably 40 μm or more which is double the size of the fungi. However, if the width of the groove 240 is too large, the antimicrobial effect by the adjacent protrusions 125 is decreased, so that the width of the groove 240 is preferably 500 μm or less.

Referring back to FIG. 2, the antimicrobial article 100 may further include a double-sided tape 260 for attaching the antimicrobial article 100 to an object and a protective layer 270 for protecting the double-sided tape 260. One surface of the double-sided tape 260 is attached to the substrate 110 and the protective layer 270 is attached to the other surface of the double-sided tape 260. The protective layer 270 prevents the double-sided tape 260 from being physically damaged or the adhesion of the double-sided tape 260 from being decreased and is removed before the antimicrobial article 100 is attached to the object.

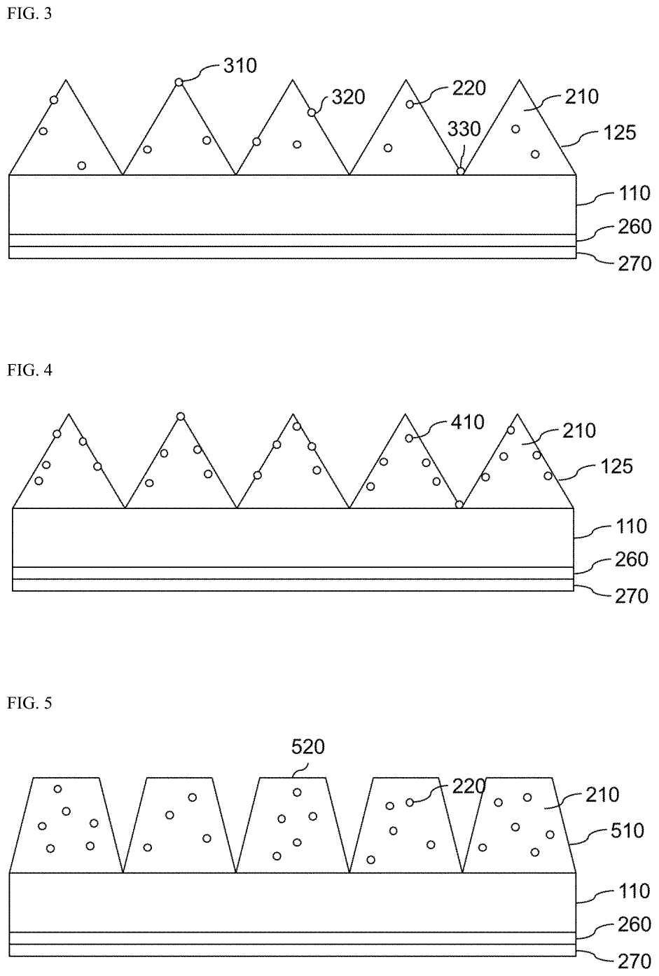

FIG. 3 is a cross-sectional view showing an antimicrobial article according to another embodiment of the present disclosure.

According to the present disclosure, in order to more greatly improve the antimicrobial effect of the antimicrobial materials, at least some of the antimicrobial materials which are dispersed in the antimicrobial layer may be at least partially exposed out of the antimicrobial layer. Referring to FIG. 3, some of the antimicrobial materials 220 in the antimicrobial layer 120 are exposed out of the protrusion 125. For example, the antimicrobial material 220 of the antimicrobial article 100 according to the present disclosure includes an antimicrobial material 310 exposed out of the top surface 250 of the protrusion 125, an antimicrobial material 320 exposed out of the side surface 230 of the protrusion 125, and an antimicrobial material 330 exposed outside near a bottom portion of the protrusion 125. These antimicrobial materials 310, 320, and 330 exposed to the outside are in direct contact with bacteria, fungi, or viruses to exhibit a more improved antimicrobial effect. As described in FIGS. 1 and 2 above, there is a low probability that bacteria, viruses, etc. will be attached to the top surface 250 of the protrusion 125 or the lower surface 245 of the groove 240, and the probability of attaching to the side surface 230 of the protrusion 125 is relatively high. Accordingly, it is preferred that the antimicrobial materials exposed out of the surface of the protrusion 125 are located on the side surface 230 of the protrusion 125 other than the top surface 250 of the protrusion 125 or the lower surface 245 of the groove 240.

In order to improve the antimicrobial effect of the antimicrobial article 100, the antimicrobial layer 120 may be configured by an antimicrobial material 220 coated with a hydrophobic material. In general, bacteria or viruses have a hydrophobic property and have a characteristic that accesses well hydrophobic materials and does not access hydrophilic materials. If the antimicrobial materials 310, 320, and 330 exposed out of the antimicrobial layer 120 are coated with the hydrophobic materials, bacteria or viruses will more access the antimicrobial materials 310, 320, and 330 exposed outside, thereby further improving the antimicrobial effect of the antimicrobial materials 310, 320, and 330. Further, the protrusion 125 may further include a hydrophilic material (not illustrated) dispersed in the polymer resin 210 so that the bacteria or viruses more access the antimicrobial materials 310, 320, and 330. Alternatively, the antimicrobial article 100 may further include a coating layer (not illustrated) of the hydrophilic material coated on the antimicrobial layer 120.

FIG. 4 is a cross-sectional view showing an antimicrobial article according to yet another embodiment of the present disclosure.

Referring to FIG. 4, the antimicrobial article 100 according to the present disclosure includes the antimicrobial layer 120 where antimicrobial materials 410 are located in close to the surface. When the antimicrobial materials 410 are located in close to the surface of the protrusion 125, a distance between the surface of the protrusion 125 and the antimicrobial materials 410 is shortened, and an antimicrobial effect on bacteria attached to the surface of the protrusion 125 may be increased. The disposing of the antimicrobial materials 410 in close to the surface of the protrusion 125, the density of the antimicrobial materials 410 in close to the surface the protrusion 125 is higher than the density of the antimicrobial materials 410 at a bottom or center of gravity of the protrusion 125. Alternatively, when the protrusion 125 is cut to a horizontal plane on the bottom of the protrusion 125, the density of the antimicrobial materials 410 at the edge of the cut cross-section is higher than the density of the antimicrobial materials 410 at the center of the cut cross-section.

Here, some of the antimicrobial materials 410, as described in FIG. 3, may be exposed out of the surface of the protrusion 125.

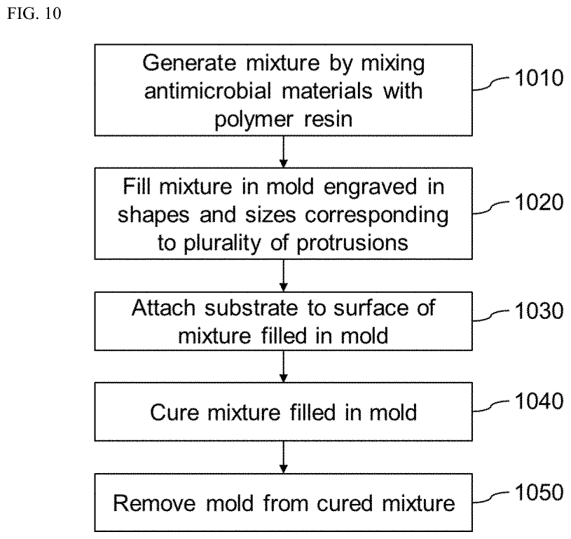

The antimicrobial article 100 according to the present disclosure may be manufactured in various shapes and sizes and the location of the antimicrobial materials in the antimicrobial layer 120 may be adjusted. This is because the antimicrobial article 100 according to the present disclosure is manufactured by a molding method unlike the existing antimicrobial films. In the antimicrobial article 100 according to the present disclosure, a mixture of mixing a polymer resin and an antimicrobial material is filled in an engraved mold and then cured, wherein the engraved mold is manufactured to correspond to the shape and size of the protrusion 125 to form the protrusion 125 having required shape and size. And the viscosity of the mixture, a time until the mixture is completely cured after the mixture is filled in the mold, or the like is adjusted to control a location of the antimicrobial materials or an aspect in which the antimicrobial materials are disposed. A method for manufacturing the antimicrobial article 100 will be described in detail with reference to FIG. 10.

FIG. 5 is a cross-sectional view showing an antimicrobial article according to yet another embodiment of the present disclosure.

Referring to FIG. 5, a protrusion 510 of the antimicrobial article 100 according to the present disclosure is formed in a shape having a flat top surface 520 and a predetermined size of area. For example, the protrusion 510 may be formed in a shape such as a truncated pyramid, a truncated cone, etc. At this time, the width of the top surface 520 of the protrusion 510 is preferably 5 μm or more so that bacteria may be sufficiently seated. Alternatively, the width of the top surface 520 of the protrusion 510 is preferably 20 μm or more so that fungi may be sufficiently seated.

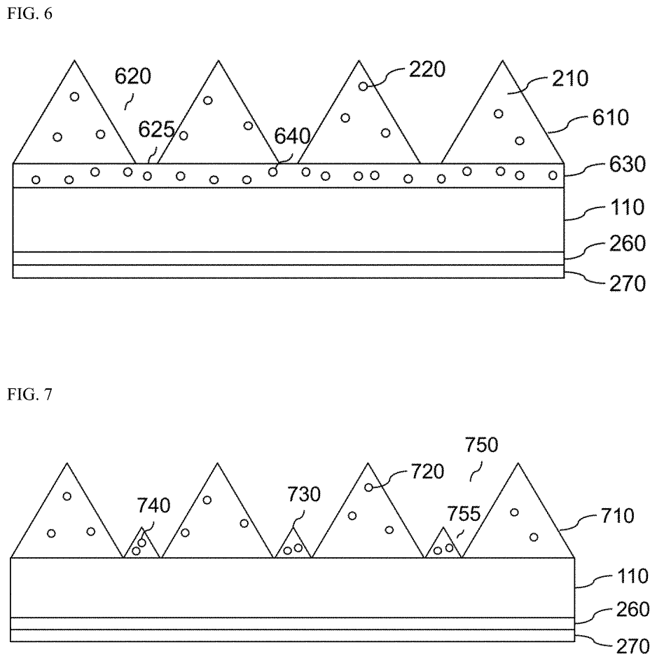

FIG. 6 is a cross-sectional view showing an antimicrobial article according to yet another embodiment of the present disclosure.

Referring to FIG. 6, among protrusions of the antimicrobial article 100 according to the present disclosure, at least some protrusions 610 are spaced apart from adjacent protrusions 610 at regular intervals. A gap between two adjacent protrusions 610 is a width of a lower surface 625 of a groove 620 formed by the corresponding protrusions 610, which is also a distance between an edge of the bottom of the protrusion 610 and an edge of the bottom of the adjacent protrusion 610. The gap between the protrusions 610 is preferably 5 μm or more so that bacteria may be sufficiently seated on the lower surface 625 of the groove 620. Alternatively, the gap between the protrusions 610 is preferably 20 μm or more so that fungi may be sufficiently seated on the lower surface 625 of the groove 620.

In order to increase the antimicrobial effect on the bacteria and the like seated on the lower surface 625 of the groove 620, the antimicrobial article 100 may further include an additional antimicrobial layer 630 provided between the substrate 110 and the antimicrobial layer 120. The additional antimicrobial layer 630 may also be formed integrally with the antimicrobial layer 120 or also formed separately from the antimicrobial layer 120. Alternately, in order to make the antimicrobial article 100 flexible, the additional antimicrobial layer 630 may be made of the same material as the substrate 110. Alternatively, it is also possible to replace the substrate 110 with a substrate in which the antimicrobial materials are dispersed.

In order to make the antimicrobial article 100 flexible and minimize the thickness of the antimicrobial article 100, it is preferred that the thickness of the additional antimicrobial layer 630 is smaller than the height of the antimicrobial layer 120 or the thickness of the substrate 110. Further, the density of antimicrobial materials 640 in the additional antimicrobial layer 630 may be different from the density of the antimicrobial materials 220 in the antimicrobial layer 120. Particularly, in order to increase the antimicrobial effect on the bacteria and the like seated on the lower surface 625 of the groove 620, it is preferred that the density of the antimicrobial materials 640 in the additional antimicrobial layer 630 is higher than the density of the antimicrobial materials 220 in the antimicrobial layer 120.

FIG. 7 is a cross-sectional view showing an antimicrobial article according to yet another embodiment of the present disclosure.

Referring to FIG. 7, the antimicrobial layer 120 includes a first protrusion 710 having a first height and a second protrusion 730 formed between the first protrusions and having a second height. At this time, the second height is lower than the first height. The second protrusion 730 between the adjacent first protrusions 710 may be one or two or more. As the second protrusion 730 is formed between the first protrusions 710, a second groove 755 by the first protrusion 710 and the second protrusion 730 is formed in a first groove 750 formed between the first protrusions 710. If there are two or more second protrusions 730 between the adjacent first protrusions 710, the second groove 755 formed by the first protrusion 710 and the second protrusion 730 or by two adjacent second protrusions 730 may be formed in the first groove 750. Here, at least one of the depth and the width of the second groove 755 may be 5 μm or more so that the bacteria or viruses may be received in the second groove 755. Alternatively, at least one of the height and the width of the second groove 755 may be 20 μm or more so that the fungi may be received in the second groove 755. By forming the second protrusion 730 between the first protrusions 710, the antimicrobial effect in the first groove 750 can be more improved. Further, the first groove 750 and the second groove 755 having different sizes are formed to divide and receive bacteria, fungi, or viruses. For example, the viruses may be received in the second groove 755, and the bacteria and fungi may be received in the first groove 750. Alternatively, the bacteria and fungi may be received in the second groove 755 and the fungi may be received in the first groove 750. In addition, the density of the antimicrobial material 720 in the first protrusion 710 and the density of the antimicrobial material 740 in the second protrusion 730 may be different from each other. However, when the density of the antimicrobial material 740 in the second protrusion 730 is higher than the density of the antimicrobial material 720 in the first protrusion 710, the antimicrobial effect in the first groove 750 may be further improved, and the antimicrobial article 100 with a sufficiently improved antimicrobial effect may be implemented without entirely increasing the density of the antimicrobial materials in the antimicrobial layer 120.

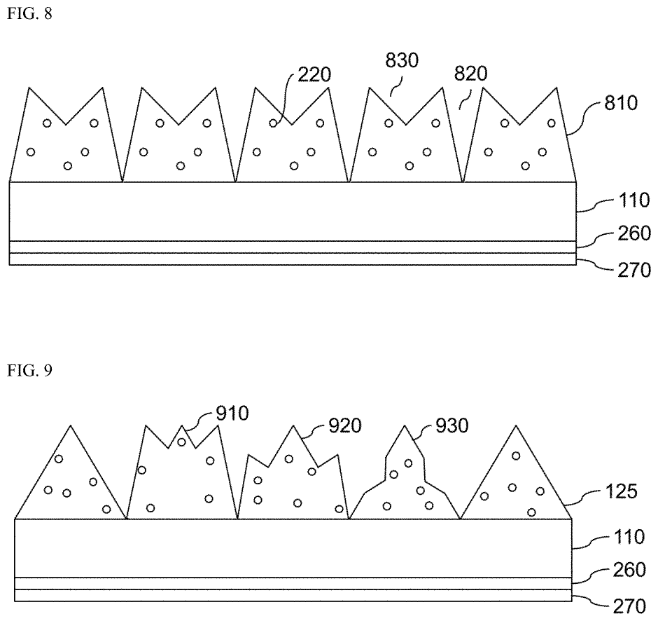

FIGS. 8 and 9 are cross-sectional views showing an antimicrobial article according to yet another embodiment of the present disclosure.

Referring to FIG. 8, a protrusion 810 of the antimicrobial layer 120 includes at least one recessed groove 830. The recessed groove 830 formed in the protrusion 810 further increases the surface area of the antimicrobial layer 120, and in addition to the groove 820 formed between the protrusions 810, bacteria, etc. are seated to increase a space surrounded by the antimicrobial materials 220. Here, the recessed groove 830 formed in the protrusion 810 is formed in an engraved shape of a cone, a truncated cone, a polypyramid, a truncated polypyramid, a hemisphere, etc. It is preferred that at least one of the depth and the width of the recessed groove 830 is 5 μm or more so that bacteria or viruses may be received in the recessed groove 830. Alternatively, it is preferred that at least one of the depth and the width of the recessed groove 830 is 20 μm or more so that fungi may be received in the recessed groove 830. According to the embodiment, the size of the groove 820 formed between the protrusions 810 and the size of the recessed space 830 are different from each other, so that the antimicrobial layer 120 may divide and receive viruses, bacteria, and fungi. For example, the viruses may be received in the recessed space 830, and the bacteria and fungi may be received in the groove 820 between the protrusions 810. Alternatively, the bacteria and viruses may be received in the recessed space 830 and the fungi may be received in the groove 820 between the protrusions 810.

In FIG. 8, the protrusion 810 includes one recessed groove 830 formed on the top of the protrusion 810, but referring to FIG. 9, a protrusion 910 may also include two or more recessed grooves, a protrusion 920 may also include a recessed groove formed at the middle of the protrusion 920 other than the top, and a protrusion 930 may include a groove recessed in a central direction from the surface of the protrusion 930 other than recessed in a lower direction from the top. That is, the protrusion may include two or more recessed grooves, and the recessed grooves of the protrusion may be recessed in a direction from the top surface to the bottom of the protrusion, a direction vertical to the bottom of the protrusion, or a direction vertical to the side surface of the protrusion.

FIG. 10 is a flowchart illustrating a method for manufacturing an antimicrobial article according to the present disclosure.

Referring to FIG. 10, first, a mixture is generated by mixing a polymer resin and an antimicrobial material (step 1010). At this time, the antimicrobial material included in the mixture may be uniformly dispersed by stirring the mixture. Next, the generated mixture is filled in a mold engraved in shapes and sizes corresponding to a plurality of protrusions (step 1020) and then a substrate is attached onto the surface of the mixture filled in the mold (step 1030). In addition, the mixture filled in the mold is cured (step 1040). When the polymer resin is a thermo-curing resin, heat is applied to the mixture, and when the polymer resin is a photo-curing resin, light is irradiated, wherein the heat is applied or the light is irradiated to an opposite side to a surface to which the substrate is attached. When the polymer resin is the photo-curing resin and the mixture is cured by irradiating the light, the light needs to pass through the mold, and thus, the mold is made of a transparent material. When the mixture is completely cured, the mold is removed from the cured mixture (step 1050).

As illustrated in FIG. 3 or 4, the mixture is filled in the mold to control a location of the antimicrobial material in the mixture or a density according to the location so that the antimicrobial materials 310, 320, 330, and 410 are exposed out of the surface of the protrusion 125 or located in close to the surface of the protrusion 125. To this end, the method for manufacturing the antimicrobial article 100 further includes a step (not illustrated) of controlling a location of the antimicrobial material in the mixture or a density according to the location, after step 1020 or 1030.

After the mixture of the polymer resin and the antimicrobial materials is filled in the mold, the antimicrobial materials in the mixture filled in the mold move to the lower portion of the mold by gravity over time. Here, since the mold is engraved in response to the shape of the protrusion, the upper portion of the mold corresponds to the bottom of the protrusion, and on the contrary, the lower portion of the mold corresponds to the upper portion of the protrusion. That is, the fact that the antimicrobial material moves to the lower portion of the mold is that the antimicrobial material moves toward the upper portion of the protrusion. When the antimicrobial material moves to the lower portion of the mold, the density of the antimicrobial materials will be increased in close to the surface of the mold. If the antimicrobial materials in the mixture are uniformly dispersed, the amount of the antimicrobial materials in the mold reaching the surface of the mold after a certain period of time will be uniform.

The antimicrobial materials in the mixture descend in a vertical direction toward the surface of the mold. Some of the antimicrobial materials come into contact with the actual mold, so that the antimicrobial materials are exposed out of the surface of the protrusion.

Depending on the viscosity of the mixture, the volume and mass of the antimicrobial material, the depth of the mold, a time until the mixture is completely cured after the mixture is filled in the mold, etc., descending speeds or aspects of the antimicrobial materials is different from each other. Accordingly, when the antimicrobial article is manufactured, it is possible to control the location of the antimicrobial materials in the protrusion or the density according to the location by adjusting at least one of the viscosity of the mixture, the volume of the antimicrobial material, the mass of the antimicrobial material, the depth of the mold, and the time until the mixture is completely cured after the mixture is filled in the mold. For example, a simple method of controlling the location or the density of the antimicrobial materials in the mixture is to wait for until a predetermined time elapses after the mixture is filled in the mold. That is, the method is to wait for until the antimicrobial materials sink at a certain distance to the lower portion of the mold.

Further, as illustrated in FIG. 6, in order to manufacture the antimicrobial article 100 provided with an additional antimicrobial layer 630 between the substrate 110 and the antimicrobial layer 120, the method may further include a step (not illustrated) of forming the additional antimicrobial layer 630 on the substrate 110 before attaching (step 1030) the substrate on the surface of the mixture filled in the mold. The additional antimicrobial layer 630 may be formed by attaching an antimicrobial film separately prepared on the substrate 110, coating another mixture of mixing the polymer resin and the antimicrobial materials on the substrate 110, etc. If the antimicrobial layer 120 and the additional antimicrobial layer 630 are integrally prepared, the antimicrobial layer 120 and the additional antimicrobial layer 630 may be formed by using one mold, so that there is no separate step for forming the additional antimicrobial layer 630.

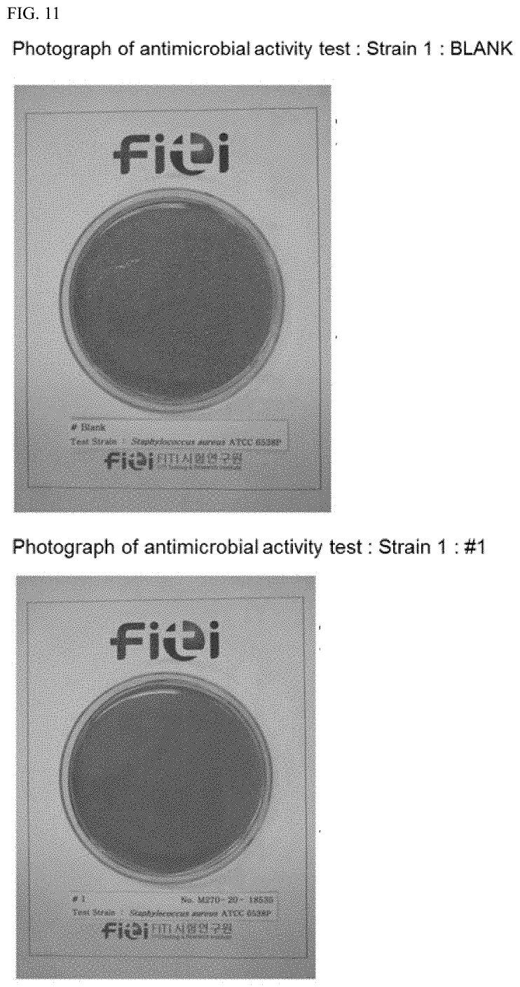

The antimicrobial effect of the antimicrobial article manufactured according to the present disclosure was measured according to the following method depending on ISO 22196:2011 and the testing results were illustrated in Table below and FIGS. 11 to 16. In Table, a unit of the microbial number was the number of bacteria/cm², and a unit of the antimicrobial activity was log, and converted to % value in Equation of (1-10^{-(Log10 reduction)})×100 to be written together in parentheses.

1) Test conditions: A test strain solution was static-cultured by 0.4 mL of an inoculation amount for 24 hours at 35±1° C. and R.H. 90% and then the microbial number was measured.

2) Known strains to be used were total 6 types, wherein Strain 1 was Staphylococcus aureus ATCC 6538P, a type of Staphylococcus, Strain 2 was Escherichia coli ATCC 8739, a type of Escherichia, Strain 3 was Klebsiella pneumoniae ATCC 4352, a type of Pneumonia, Strain 4 was Salmonella typhimurium KCTC 1925, a type of Salmonella, Strain 5 was Pseudomonas aeruginosa ATCC 27853, a type of Pseudomonas, and Strain 6 was Staphylococcus aureus ATCC 33591 (Methicillin-resistant strains of Staphylococcus aureus), a type of superbacteria.

TABLE 1

| | | | Anti- |
|---|---|---|---|
| | | | microbial |
| Classification | | BLANK | article #1 |
| Strain 1 | Microbial number immediately | 2.0 × 10⁴ | — |
| | after inoculation | | |
| | Microbial number after 24 hours | 3.3 × 10⁴ | <0.63 |
| | Antimicrobial activity | — | 4.7 (99.9%) |
| Strain 2 | Microbial number immediately | 1.7 × 10⁴ | — |
| | after inoculation | | |
| | Microbial number after 24 hours | 1.1 × 10⁵ | <0.63 |
| | Antimicrobial activity | — | 6.2 (99.9%) |
| Strain 3 | Microbial number immediately | 1.8 × 10⁴ | — |
| | after inoculation | | |
| | Microbial number after 24 hours | 5.1 × 10⁵ | <0.63 |
| | Antimicrobial activity | — | 5.9 (99.9%) |
| Strain 4 | Microbial number immediately | 1.1 × 10⁴ | — |
| | after inoculation | | |
| | Microbial number after 24 hours | 3.6 × 10⁵ | <0.63 |
| | Antimicrobial activity | — | 5.7 (99.9%) |
| Strain 5 | Microbial number immediately | 2.0 × 10⁴ | — |
| | after inoculation | | |
| | Microbial number after 24 hours | 2.5 × 10⁵ | <0.63 |
| | Antimicrobial activity | — | 5.5 (99.9%) |
| Strain 6 | Microbial number immediately | 2.0 × 10⁴ | — |
| | after inoculation | | |
| | Microbial number after 24 hours | 3.9 × 10⁴ | <0.63 |
| | Antimicrobial activity | — | 4.7 (99.9%) |

FIG. 11 illustrates photographs of Antimicrobial article #1 according to the present disclosure and Comparative Example BLANK when Strain 1 was cultured. Referring to Table 1 and FIG. 11, in Antimicrobial article #1 according to the present disclosure, it can be seen that since the microbial number is 0.63/cm² or less after Strain 1 is cultured for 24 hours, the microbial number of 99.9% is eradicated as compared with the initial microbial number.

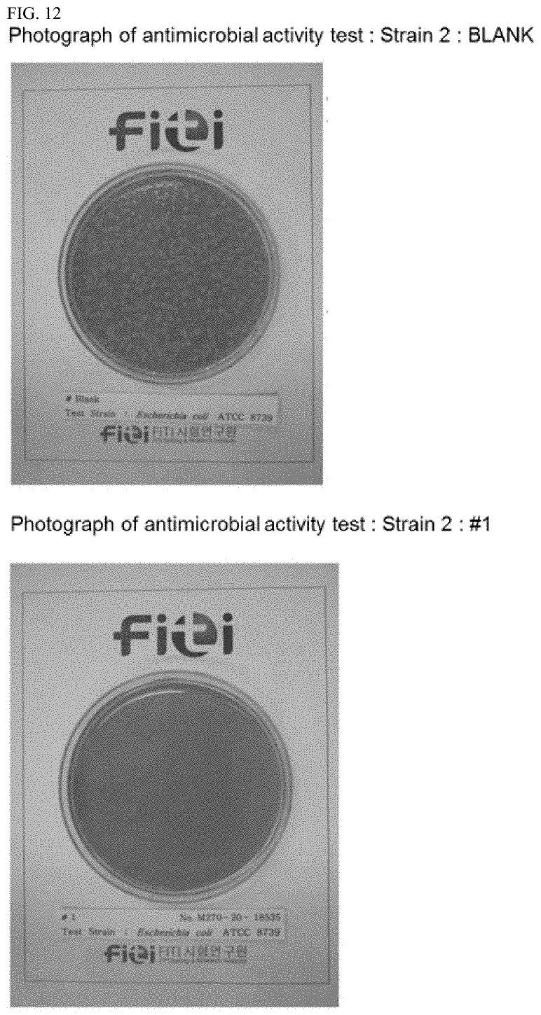

FIG. 12 illustrates photographs of Antimicrobial article #1 according to the present disclosure and Comparative Example BLANK when Strain 2 was cultured. Referring to Table 1 and FIG. 12, in Antimicrobial article #1 according to the present disclosure, it can be seen that since the microbial number is 0.63/cm² or less after Strain 2 is cultured for 24 hours, the microbial number of 99.9% is eradicated as compared with the initial microbial number.

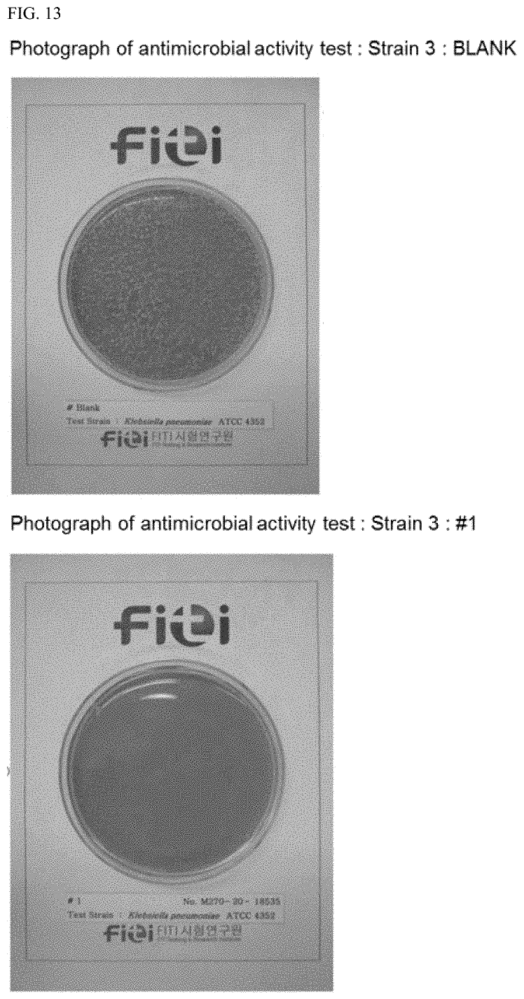

FIG. 13 illustrates photographs of Antimicrobial article #1 according to the present disclosure and Comparative Example BLANK when Strain 3 was cultured. Referring to Table 1 and FIG. 13, in Antimicrobial article #1 according to the present disclosure, it can be seen that since the microbial number is 0.63/cm² or less after Strain 3 is cultured for 24 hours, the microbial number of 99.9% is eradicated as compared with the initial microbial number.

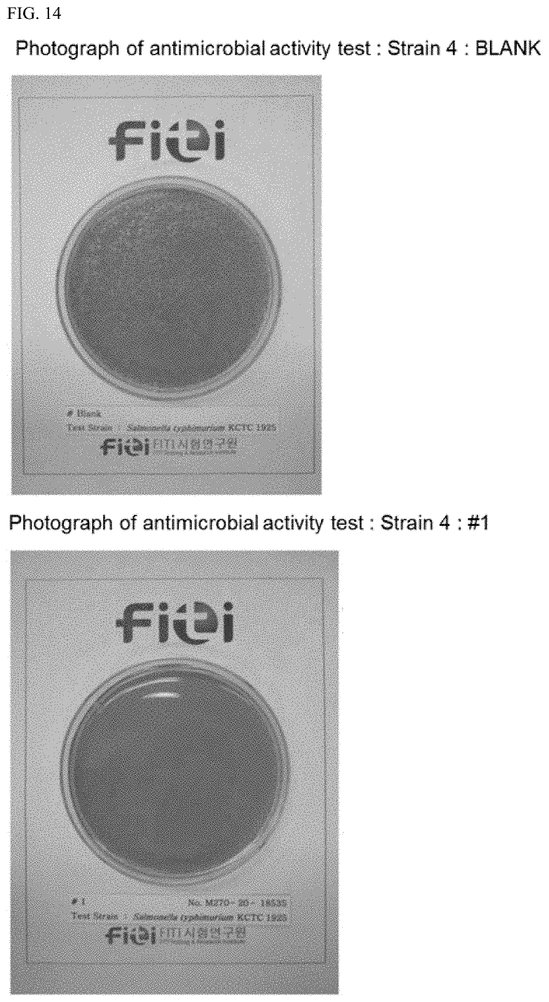

FIG. 14 illustrates photographs of Antimicrobial article #1 according to the present disclosure and Comparative Example BLANK when Strain 4 was cultured. Referring to Table 1 and FIG. 14, in Antimicrobial article #1 according to the present disclosure, it can be seen that since the microbial number is 0.63/cm² or less after Strain 4 is cultured for 24 hours, the microbial number of 99.9% is eradicated as compared with the initial microbial number.

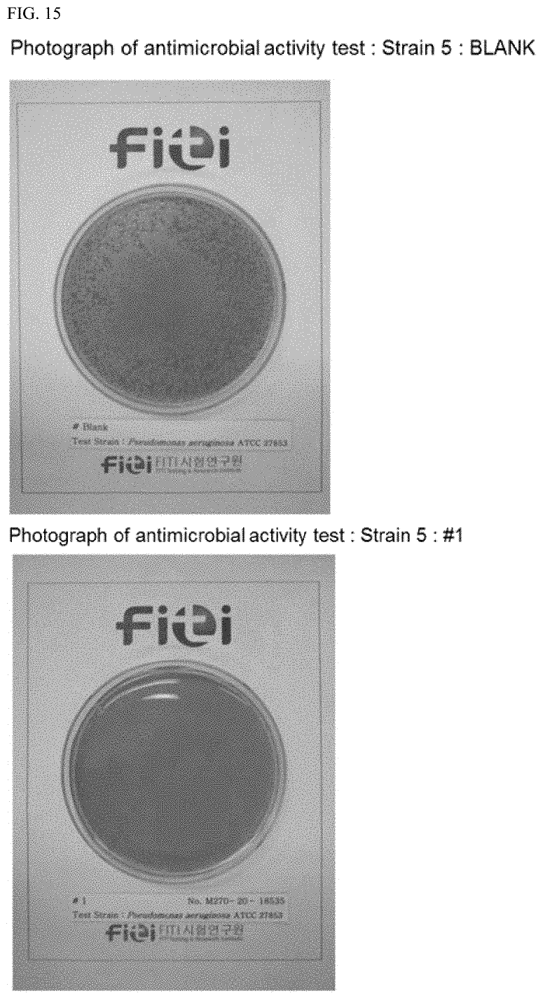

FIG. 15 illustrates photographs of Antimicrobial article #1 according to the present disclosure and Comparative Example BLANK when Strain 5 was cultured. Referring to Table 1 and FIG. 15, in Antimicrobial article #1 according to the present disclosure, it can be seen that since the microbial number is 0.63/cm² or less after Strain 5 is cultured for 24 hours, the microbial number of 99.9% is eradicated as compared with the initial microbial number.

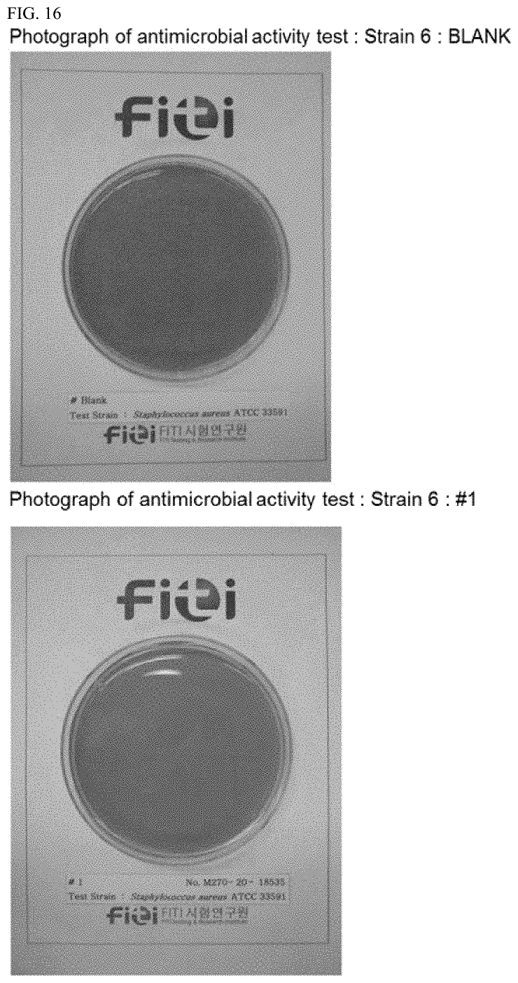

FIG. 16 illustrates photographs of Antimicrobial article #1 according to the present disclosure and Comparative Example BLANK when Strain 6 was cultured. Referring to Table 1 and FIG. 16, in Antimicrobial article #1 according to the present disclosure, it can be seen that since the microbial number is 0.63/cm² or less after Strain 6 is cultured for 24 hours, the microbial number of 99.9% is eradicated as compared with the initial microbial number.

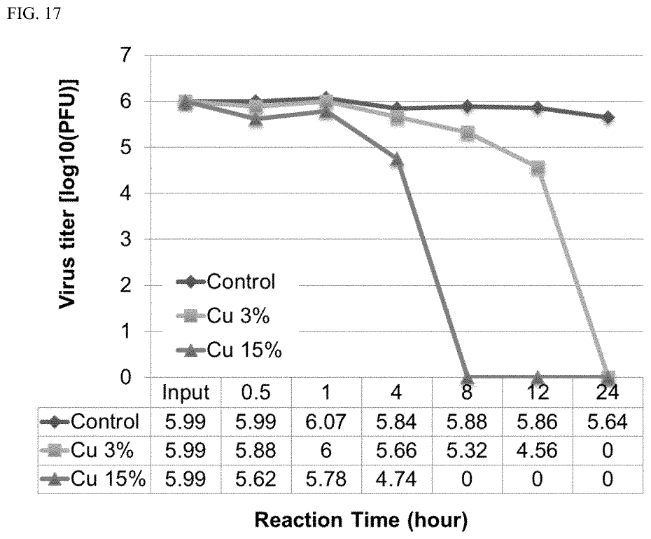

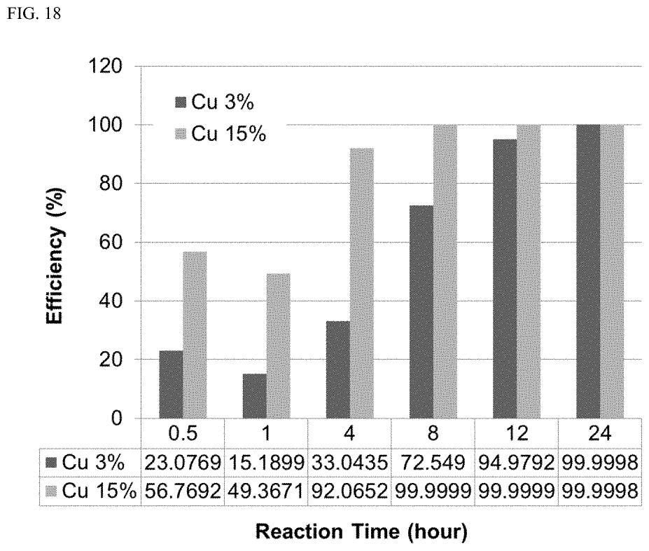

Further, an antiviral effect of the antimicrobial article manufactured according to the present disclosure was tested and measured according to the following method and the testing results were illustrated in FIGS. 17 and 18.

1) Test method: In order to infect an antimicrobial article with viruses, 50 μL of SARS-CoV-2 virus diluted at a titer of 2.0×10′ PFU/mL was used and applied on surfaces of two kinds of antimicrobial articles containing copper with weight ratios of 3% and 15%, respectively, and a vessel was sealed using a parafilm and then reacted for 30 min, 1 hour, 4 hours, 8 hours, 12 hours, and 24 hours. After each reaction, the viruses on the surfaces of the antimicrobial articles were recovered with a 3 mL PBS solution and then the recovered PBS solution was diluted in a 10-fold step. This was infected in a Vero cell line and then cultured in a 37° C., 5% CO2 incubator, and the number of living viruses was measured by counting plaques to be formed. As a control of the two kinds of antimicrobial articles, a PET film without containing an antimicrobial material was compared in the same manner.

2) Viruses: Covid-19 virus (SARS-CoV-2) 1.35×10⁸ PFU/mL of BetaCoV/Korea/KCDC03/2020 (NCCP no. 43326) was used, Vero cells monolayer-cultured in a T-75 flask are washed with PBS and inoculated with viruses at 0.01 of Multiplicity of infection (MOI), and after infection, a virus culture solution was obtained on 72 hours and centrifuged for 10 minutes at 3,000 rpm and then a supernatant was filtered and used with a 0.45 μm filter.

3) Cell line: Vero cells (Monkey kidney cell line, producer: Working cell bank (WCB), supplier: KFDA) were cultured in 5% CO2, 37° C. conditions and used.

4) Plaque formation test: When the cells infected with the virus were stained with a dye (crystal violet), living cells which were not infected with the virus are stained, and dead cells with viral infection are not stained, and as a result, white ball-shaped plaques are observed at this part. A known infectious virus solution was applied on the antimicrobial article and after a predetermined time, the viruses were recovered from the surface and infected in Vero cells for 1 hour at 37° C., and then overlaid on cells in an agar medium and cultured for 3 to 4 days. Thereafter, the number of plaques observed by staining infected cells with crystal violet was measured by a plaque forming unit (PFU).

FIG. 17 is a graph showing aspects of reducing a virus infection titer for each time on two kinds of antimicrobial articles according to the present disclosure and a control sample and illustrates virus titer values (Unit: log₁₀(PFU)). In antimicrobial articles containing copper at weight ratios of 3% and 15%, an aspect of reduced viruses was shown from 4 hours and infectious viruses were not detected at 24 hours. Particularly, in the antimicrobial article containing copper at the weight ratio of 15%, no infectious viruses have been detected after 8 hours, and in the antimicrobial article containing copper at the weight ratio of 3%, a somewhat gentle reduction aspect was shown and viruses with more than 10^{4.56} PFU were detected at 12 hours. On the other hand, in the control, the viruses of 10^{5.64} to 10^{6.07} PFU were detected from the initial to 24 hours, which was a very contrasting result with antimicrobial articles according to the present disclosure.

FIG. 18 is a graph and Table showing the antiviral efficiency (unit: %) of two kinds of antimicrobial articles according to the present disclosure and a control sample. As compared with the control, in the antimicrobial article containing copper at the weight ratio of 3%, the antiviral efficiency of 72.5490% and 94.9792% was shown in reaction times of 8 hours and 12 hours, respectively, and in the antimicrobial article containing copper at the weight ratio of 15%, the antiviral efficiency of 99.9999% was shown in both reaction times of 8 hours and 12 hours.

Although the preferred embodiment of the present disclosure has been described and illustrated using specific terms, these terms are only to clearly describe the present disclosure. It will be apparent that the embodiments of the present disclosure and the described terms can make various changes and modifications without departing from the technical spirit and the scope of the following claims. Thus, the modified embodiments should not be understood individually from the spirit and scope of the present disclosure, and will cover the appended claims of the present disclosure.

What is claimed is:

1. An antimicrobial article comprising:
a flexible substrate; and
a plurality of protrusions which includes a crosslinked polymer resin and antimicrobial materials dispersed in the polymer resin and is formed on at least one surface of the substrate to form grooves in which at least one of bacteria, fungi, and viruses may be received.

2. The antimicrobial article of claim 1, wherein a width of a lower surface of a groove in which at least one of bacteria, fungi, and viruses may be received is smaller than a size of at least one of bacteria, fungi, and viruses and at least one of a depth and the width of the groove is equal to or larger than the size of at least one of bacteria, fungi, and viruses.

3. The antimicrobial article of claim 2, wherein density of the antimicrobial materials is higher in close to a surface of a protrusion than a center of gravity of the protrusion, or
higher in close to an edge of a cut cross section than a center of the cut cross section when the protrusion is cut to a horizontal plane with a bottom of the protrusion.

4. The antimicrobial article of claim 2, wherein at least some of the antimicrobial materials are at least partially exposed out of a surface of a protrusion.

5. The antimicrobial article of claim 4, wherein the antimicrobial materials exposed out of the surface of the protrusion are coated with a hydrophobic material.

6. The antimicrobial article of claim 4, wherein the polymer resin of the protrusion further includes a hydrophilic material.

7. The antimicrobial article of claim 2, wherein at least one of the depth and the width of the groove in which at least one of bacteria, fungi, and viruses may be received is 5 μm or more.

8. The antimicrobial article of claim 2, wherein a width of a top surface of a protrusion is smaller than the size of the at least one of bacteria, fungi, and viruses.

9. The antimicrobial article of claim 2, wherein at least one of the protrusions includes a recessed groove in which at least one of bacteria, fungi, and viruses may be received, and
at least one of the depth and the width of the recessed groove is equal to or larger than the size of at least one of bacteria, fungi, and viruses.

10. The antimicrobial article of claim 9, wherein the recessed groove is recessed in a vertical direction to a bottom or a side surface of a protrusion.

11. An antimicrobial article comprising:
a flexible substrate;
a plurality of first protrusions which is formed at a first height on at least one surface of the flexible substrate and includes a crosslinked polymer resin and antimicrobial materials dispersed in the polymer resin; and
at least one second protrusion which is formed between at least two first protrusions among the first protrusions, has a second height smaller than the first height, and includes a crosslinked polymer resin and antimicrobial materials dispersed in the polymer resin,
wherein at least one groove in which at least one of bacteria, fungi, and viruses may be received is formed by a first protrusion and a second protrusion.

12. The antimicrobial article of claim 11, wherein a width of a lower surface of a groove in which at least one of bacteria, fungi, and viruses may be received is smaller than a size of at least one of bacteria, fungi, and viruses, and
at least one of a depth and the width of the groove in which at least one of bacteria, fungi, and viruses may be received is equal to or larger than the size of at least one of bacteria, fungi, and viruses.

13. The antimicrobial article of claim 12, wherein density of the antimicrobial materials is higher in close to a surface of the second protrusion than a center of gravity of the second protrusion, or
higher in close to an edge of a cut cross section than a center of the cut cross section when the second protrusion is cut to a horizontal plane with a bottom of the second protrusion.

14. The antimicrobial article of claim 12, wherein at least some of the antimicrobial materials are at least partially exposed out of the surface of the second protrusion.

15. The antimicrobial article of claim 14, wherein the antimicrobial materials exposed out of the surface of the second protrusion are coated with a hydrophobic material.

16. The antimicrobial article of claim 12, wherein a width of a top surface of at least one of the first protrusion and the second protrusion is smaller than the size of at least one of bacteria, fungi, and viruses.

17. A method for manufacturing an antimicrobial article, in a method for manufacturing a polishing article formed with a plurality of protrusions, the method comprising:
generating a mixture by mixing uniformly antimicrobial materials with a polymer resin;
filling the mixture in a mold engraved in shapes and sizes corresponding to the plurality of protrusions;
attaching a substrate to a surface of the mixture filled in the mold;
curing the mixture filled in the mold; and
removing the mold from the cured mixture.

18. The method of claim 17, further comprising:
controlling a location of the antimicrobial materials in the mixture or a density according to the location.

19. The method of claim 18, wherein the controlling of the location of the antimicrobial materials in the mixture or the density according to the location is to move the antimicrobial materials in the mixture in close to a surface of the mold.

20. The method of claim 18, wherein the location of the antimicrobial materials or the density according to the location is controlled by at least one of a volume of the antimicrobial materials and a mass of the antimicrobial materials and a time until the mixture is completely cured after the mixture is filled in the mold.
